(19) United States
(12) Patent Application Publication
(10) Pub. No.: US 2007/0194542 A1
(43) Pub. Date: Aug. 23, 2007

(54) Motorized hunting cart

(76) Inventor: Gary J. Dixon, Mark, IL (US)

Correspondence Address: Raymond M. Galasso;Galasso & Associates LP, P.O. Box 26503, Austin, TX, 78755-0503, US

(21) Appl. No.: 11/359,034

(22) Filed: Feb. 21, 2006

(51) Int. Cl. B62B 1/00

(52) U.S. Cl. 280/47.24

(57) ABSTRACT

A hunting cart designed to assist a hunter with transporting objects such as hunting equipment and large game. The cart includes a pair of side rails that are arcuate in shape and parallel with each other. Interposed the side rails are a plurality of cross support members, a handle and an end rail defining the frame of the cart. A drive assembly is present that is operably connected to an axle, which is rotatably mounted to two wheels. The drive assembly includes an electric motor, a renewable power source and a chain.

### FIELD OF THE INVENTION

The present invention relates to a handcart, more specifically but not by way of limitation, to a hand cart that utilizes a motor to operably engaged wheels to assist hunters to carry heavy loads such as, but not limited to, large game, over a variety of terrains.

### BACKGROUND

Hunting large game such as deer is a sport that is enjoyed by thousands of individuals. Typically when engaged in the sport of hunting, a hunter will traverse through a desired area such as a forest. It is common for hunters to walk many miles to a particular hunting destination. Conversely, some hunters choose to travel periodically throughout the day. Hunters typically carry gear such as food rations and other hunting supplies during their hunting trip. The terrain that hunters must enter is usually rough with a variety of hills and slopes. Navigating this type of terrain while carrying heavy loads can present several obstacles and hazards to the hunter.

Carrying heavy loads while traversing treacherous terrain can be present a significant potential health hazard to the hunter. As the treacherous terrain does not provide a solid horizontal support structure for walking, the hunter is at risk for potential back, leg or ankle injury. Furthermore, while traversing long distances across such terrain the hunter's muscles can become fatigued, this can increase the chance for injury.

Another issue occurs when the hunter has been successful and has killed a large game animal such as a deer. Typically the hunter is a significant distance away from his vehicle. Transporting the deer and the hunting equipment is presents a significant challenge for a single individual. Conventional carts have provided some assistance with this task, however pulling a manual cart that is loaded with hunting equipment and/or wild game across the difficult terrain has proven to be unachievable for many hunters.

Accordingly, there is a need for a handcart that facilitates the transportation of heavy loads such as but not limited to hunting equipment and large wild game across a variety of terrains that provides motorized assistance for moving the cart.

### SUMMARY OF THE INVENTION

It is the object of the present invention to provide a hand operated cart designed to assist hunters transport heavy loads such as hunting equipment and large wild game over a variety of terrains.

It is a further object of the present invention to provide a hand operated cart that provides a method of motorized movement to assist the hunter in moving the cart across a variety of terrains.

It is another object of the present invention to provide a hand operated cart with motorized movement assistance that is collapsible so as to facilitate storage in small areas.

Yet another object of the present invention is to provide a hand operated cart that provides a method of motorized movement that has wheels that are resistant to puncture damage.

It is a further object of the present invention to provide a hand operated cart with motorized movement assistance that has an integrated brake system.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWING

A more complete understanding of the present invention may be had by reference to the following Detailed Description and appended claims when taken in conjunction with the accompanying Drawing wherein:

FIGURE 1 illustrates a perspective view of a preferred embodiment of the present invention.

### DETAILED DESCRIPTION

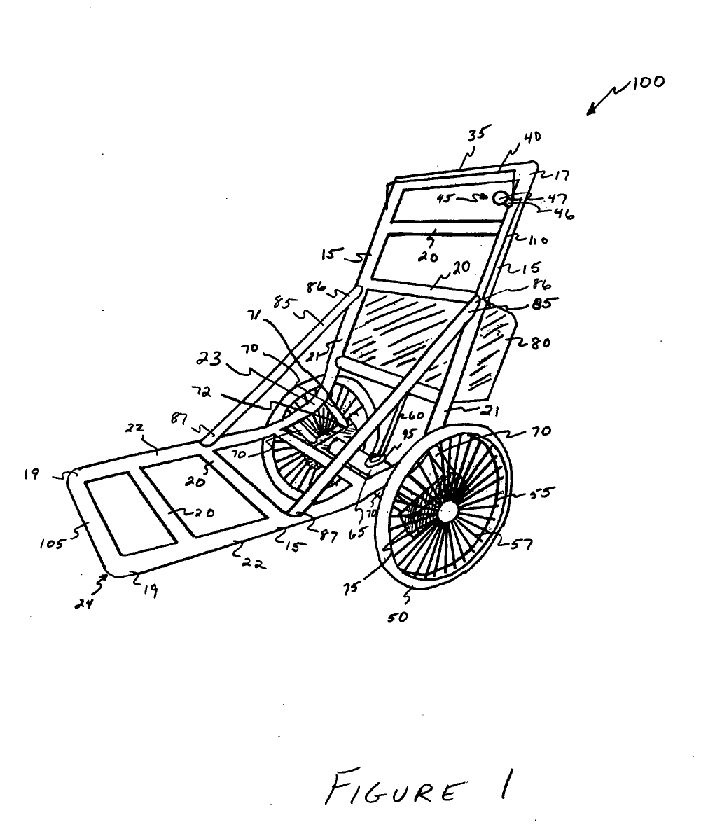

Referring to the embodiment in FIGURE 1 wherein like elements are designated with identical reference numerals throughout the figure and wherein various elements depicted therein are not necessarily drawn to scale, and in particular in FIGURE 1 there is illustrated a hand cart 100 that is constructed according the principles of the present invention.

The hand cart 100 comprises two outer side rails 15 that are generally tubular in shape. The outer side rails 15 are parallel with respect to each other and define the peripheral edge of the hand cart 100. The outer side rails 15 are manufactured from a durable rigid and lightweight material. More specifically but not by way of limitation the outer side rails 15 are manufactured from aluminum tubing. The outer side rails 15 are manufactured by conventional methods such as bending in such a manner whereby the outer side rails 15 are arcuate in shape creating an upper section 21 and a lower section 22 for each outer side rail 15. The outer side rails 15 are bent in whereby the lower section 22 and the upper section 21 extend in an upward direction with respect to the midpoint 23 of the outer side rails 15.

Interposed to the outer side rails 15 and generally perpendicular thereto is a plurality of cross support members 20. The cross support members 20 are tubular in shape and function to connect the outer side rails 15 and combine therewith to define the frame 24 of the hand cart 100. The cross support members 20 are manufactured from a durable rigid material such as but not limited to aluminum. The cross support members 20 are mechanically fastened to the outer side rails 15 by conventional methods such as but not limited to welding. While no specific numbers of cross support members 20 are required good results have been achieved with six cross support members.

Intermediate the first ends 17 of the upper section 21 of the outer side rail 15 is a handle 35. The handle 35 is fastened to the first ends of the outer side rail 15 by conventional methods such as welding. The handle 35 is tubular in shape and is manufactured from a suitable durable and rigid material such as aluminum. Although the handle 35 is shown as being a tubular shaped piece of material in the drawing submitted herewith, it is contemplated within the scope of the present invention that the handle 35 could be coated with a material that would facilitate a method of gripping. More specifically but not by way of limitation the handle could be coated with a rubber surface to produce a more secure method of gripping the hand cart 100 while traversing across a given terrain.

Distally located from the handle 35 proximate to the second ends 19 of the outer side rails 15 and interposed thereto is an end rail 105. The end rail 105 is secured to the second ends 19 of the side outer rails 15 by conventional methods such as but not limited to welding. The end rail 105 in combination with the lower section 22 of the outer side rails 15 serves to define the lower platform area 97 of the hand cart 100. The end rail 105 also functions to support the hand cart in its first position whereby the end rail 105 is adjacent to a suitable horizontal support structure such as the ground. In this position a hunter can load objects onto the lower platform area 97.

Mechanically fastened by conventional methods such as welding to the outer side rails 15 is a pair of side brace members 85. The side brace members 85 are constructed from a suitable rigid material such as but not limited to aluminum tube. The side brace members 85 have a first end 86, which is fastened to the upper section 21 of the outer side rail 15. The second end 87 is mechanically fastened to the lower section 22 of the same outer side rail 15. While no specific attachment point is necessary, the first end 86 and second end 87 should be attached along the outer side rail on opposite sides of the midpoint 23. This positioning allows the side brace members 85 to provide the structural support necessary for the outer side rails 15 when the hand cart 100 is engaged with heavy loads. Although the side brace members 85 and outer side rails 15 are illustrated in the drawings submitted herewith and being a solid tubular structure, it is contemplated within the scope of the present invention that proximate to the first end 86 and the second end 87 of the side brace members 85 a conventional hinge would be located thereby facilitating the folding of the upper section 21 and the lower section 22 of the outer side rails 15 towards and be generally adjacent to the side brace members 85 for ease of storage.

Integrally connected with the outer side rails 15 and extending downward therefrom are four axle support members 70. Two axle support members 70 are fastened to each outer side rails 15. Each axle support member 70 is proximate to the midpoint 26 and located adjacently opposite thereto. The axle support members 70 have a first end 71 that is fastened to the outer side rails 15 by conventional methods such as welding. Each pair of axle support members 70 along the outer side rails 15 are mounted on opposite sides of the midpoint 26 whereby one axle support member 70 is proximate to the upper section 21 and the opposite axle support member 70 is mounted on the same outer side rail 15 is proximate to the lower section 22 of the outer side rail 15. This allows the hand cart 100 to be easily managed and balanced on the wheels 55 when in use across different terrains with a heavy load.

Surroundably mounted to the axle support members 70 are a two axle connection members 75. The axle connection members 75 are generally square in shape and are fastened by conventional methods to the second ends 72 of the axle support member 70 distal to the outer side rail 15. The axle connection members 75 are configured to receive therein axle 65. The axle 65 is a conventional metal rod having two ends. The axle 65 is rotatably interposed the axle connection members 75. The ends of the axle 65 extending outward therefrom are mechanically fastened by conventional methods to a wheel 55. The wheel 55 is a conventional wheel that utilizes a plurality of spokes 57 for structural support. The wheel 55 further includes an inflatable tire 50 that functions to provide traction across different types of terrains. It is further contemplated within the scope of the present invention that the tire 50 is made from a material that is resistant to punctures or is equipped with a self-sealing air tube in the event that an object protrudes through the tire 50.

Intermediate along the axle 65 is a sprocket 95. The sprocket 95 is mechanically fastened to the axle by conventional methods such as but not limited to bolts. The sprocket 95 is a standard sprocket that is annular in shape and has a plurality of teeth disposed along a peripheral edge that is configured to receive thereon one end of a chain 60. The chain 60 serves to operably connect the drive assembly 80 with the axle 65. Those skilled in the art should recognize that numerous different devices could be used in place of and/or in conjunction with the chain 60. More specifically but not by way of limitation, a belt or shaft could be used to operably interconnect the drive assembly 80 with the axle 65. The drive assembly 80 is positioned intermediate the outer side rails 15 proximate to the upper section 21 of the hand cart 100. The drive assembly 80 is secured by conventional methods to the outer side rails 15 opposite the first end 86 of the side brace members 85. The drive assembly 80 is a generally rectangular box constructed of suitable weatherproof material such as but not limited to aluminum. The drive assembly 80 has contained therein a conventional DC electric motor and a renewable power source such as a DC battery. Those skilled in the art will recognize that numerous different types of motors could be utilized in place of and/or in conjunction with the electric motor referenced herein. More specifically but not by way of limitation, the drive assembly 80 could have disposed therein a conventional gas engine and fuel supply tank. The drive assembly 80 further contains a sprocket that is configured to receive one end of the chain 60. The drive assembly 80 being operably connected to the axle 65 via the chain 60 functions to provide the user of the hand cart 100 a method of providing power assistance to drive the wheels 55.

The drive assembly 80 is controlled with a lever 40 that is pivotally mounted adjacent to the handle 35 to the outer side rails 15. The lever 40 consists of a first end and a second end with each end being pivotally secured to an outer side rail 15 proximate to the first end 17. The lever 40 is a conventional mechanical lever that is connected to the drive assembly 80 via a cable 110. The cable 110 is secured internally by mechanical methods along the outer side rail 15. The lever 40 has a first position in which the motor disposed within the drive assembly 80 is disengaged with the chain 60 thereby eliminating the transfer of power from the drive assembly 80 to the axle 65. In its second position the lever 40 is biased against the handle 35 by a user's hand. In its second position the lever 40 biases the cable 110 which functions to engage the drive assembly 80 with the chain 60. As the chain 60 is operably engaged to the axle 65, this provides motorized assistance in moving the hand cart 100 across the desired terrain.

Integrally mounted to one of the outer side rails 15 is a throttle 45. The throttle 45 functions to control the speed of the hand cart 100 once the lever 40 is engaged in its second position. The throttle 45 is manufactured with a rod 46 and a knob 47 secured thereto. The throttle shift 45 is manufactured from suitable durable materials such as but not limited to plastic.

Although the hand cart 100 is illustrated with only a lever 40 pivotally mounted to the handle 35, it is contemplated within the scope of the present invention that the hand cart 100 could have integrated thereon a standard mechanical caliper brake system to provide assistance to the user in slowing the forward or backward movement of the hand cart 100 when traversing across sloped terrain. It is further contemplated within the scope of the invention that the frame 24 be coated with a durable coating material in a plurality of colors such as but not limited to powder coating to provide protection for the frame 24. Those skilled in the art should recognize that the frame 24 could be constructed from numerous different materials in a variety of shapes and sizes in place of and/or in conjunction with the materials suggested herein. Furthermore, those skilled in the art should also recognize that the frame 24 could be manufactured with different wall thicknesses in order to manufacture different models having distinct load capabilities. It should further be recognized that the hand cart 100 described herein could be utilized for numerous applications in addition to the aid in transportation of hunting equipment and large wild game. More specifically but not by way of limitation the hand cart 100 could be utilized to transport groceries or picnic equipment.

Referring in particular to the drawing submitted herewith, a description of the operation of the hand cart 100 is as follows. A user will place the desired material to be transported such as hunting equipment or large wild game on the lower platform area 97 of the hand cart 100 while the hand cart 100 is in its first position whereby the end rail 105 is adjacent to a suitable horizontal support structure such as the ground. The user then applies the necessary force to the handle 35 in a downward direction to place the hand cart 100 in its second position whereby the hand cart 100 is centrally balanced over the wheels 55. The user then pulls the cart in a desired direction to begin the transportation process. During the transportation process the user can engage the lever 40 in its second position thereby activating the chain 60 that operably connects the drive assembly 80 to the axle 65. The user can further control the speed of the hand cart 100 by utilizing the throttle 45.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A hand operated utility cart comprising:
a frame, said frame further including two side rails, said side rails being configured in a parallel manner and being generally arcuate in shape, said side rails having a first end and a second end; at least one cross support member, said cross support member interposed said side rails and generally perpendicular thereto; said cross support member for supporting objects superposed on said hand cart; a handle, said handle interposed said side rails proximate to said first end, said handle allowing a user to engage said hand cart; an end rail, said end rail proximate to said second end of said side rails, said end rail being intermediate said side rails and generally perpendicular thereto, said end rail for supporting said hand cart in a first position against a horizontal support structure;
an axle, said axle connected to said frame, said axle being rotatably mounted thereto;
two wheels, said wheels being rotatably mounted to said axle on opposite sides of said frame, said wheels for providing movement of said hand cart; and
a drive assembly, said drive assembly interposed said side rails, said drive assembly operably connected to said axle, said drive assembly for moving said hand cart.

2. The hand cart as recited in claim 1, and further including a lever pivotally mounted intermediate said side rails, said lever being proximate said first end of said side rails adjacent to said handle, said lever for engaging said drive assembly.

3. The hand cart as recited in claim 2, and further including a throttle, said throttle integrally mounted to one of said side rails proximate to said first end, said throttle for controlling the movement speed of said cart upon engagement of said drive assembly.

4. The hand cart as recited in claim 3, wherein said drive assembly further includes a motor, a renewable power source connected thereto and a chain.

5. The hand cart as recited in claim 4, and further including a sprocket, said sprocket mounted intermediate on said axle, said sprocket configured to receive thereon said chain from said drive assembly.

6. The hand cart as recited in claim 5, wherein said motor in said drive assembly is an electric motor.

7. The hand cart as recited in claim 6, wherein said frame is manufactured from aluminum.

8. A hand operated utility cart for transporting hunting equipment and wild game comprising:
a frame, said frame further including two side rails, said side rails being configured in a parallel manner, said side rails having an upper section and a lower section with a midpoint intermediate said upper section and said lower section, said side rails further being arcuate in shape with said upper section and said lower section extending in an upwards direction from said midpoint, said side rails having a first end and a second end; six cross support members, said cross support members interposed said side rails and perpendicular thereto; said cross support member for supporting objects superposed on said hand cart; a handle, said handle interposed said side rails proximate to said first end of said side rails, said handle allowing a user to engage said hand cart; an end rail, said end rail intermediate said side rails and perpendicular thereto, said end rail for supporting said hand cart in a first position against a horizontal support structure;
four axle support members, said axle support members having a first end and a second end, said first end of said axle support members secured to said side rails,
an axle, said axle connected to said frame, said axle being rotatably mounted thereto;
two axle connection members, said axle connection members being secured to said second end of said axle support members, said axle being rotatably mounted to said axle connection members;
two wheels, said wheels being rotatably mounted to said axle on opposite sides of said frame, said wheels for providing movement of said hand cart; and
a drive assembly, said drive assembly interposed said side rails proximate said upper section, said drive assembly operably connected to said axle, said drive assembly for moving said hand cart.

9. The hand cart as recited in claim 8, wherein said drive assembly further includes an electric motor, a battery and a chain.

10. The hand cart as recited in claim 9, and further including a sprocket, said sprocket mounted intermediate on said axle, said sprocket configured to receive said chain thereon.

11. The hand cart as recited in claim 10, and further including a lever, said lever pivotally mounted interposed said side rails proximate to said first end of said side rails, said lever having a first position and a second position, said lever configured for controlling the engagement of said drive assembly to said axle, said lever being operably connected to said drive assembly with a cable.

12. The hand cart as recited in claim 11, wherein said drive assembly is operably engaged with said axle when said lever is in said second position whereby said lever is biased against said handle.

13. The hand cart as recited in claim 12, and further including a throttle, said throttle for controlling the speed of movement of said hand cart when said drive assembly is movably engaged with said axle.

14. The hand cart as recited in claim 13, wherein said frame is manufactured from aluminum and said frame further includes a powder coating disposed substantially thereon.

15. A hand operated utility cart for transporting hunting equipment and wild game comprising:
two side rails, said side rails being configured in a parallel manner, said side rails having an upper section and a lower section with a midpoint intermediate said upper section and said lower section, said side rails further being arcuate in shape with said upper section and said lower section extending in an upwards direction from said midpoint, said side rails having a first end and a second end;
six cross support members, said cross support members interposed said side rails and perpendicular thereto; said cross support members for supporting objects superposed on said hand cart, said cross support members and said side rails defining a platform area for receiving objects thereon;
a handle, said handle interposed said side rails proximate to said first end of said side rails, said handle providing a structure for a user to engage said hand cart;
an end rail, said end rail proximate to said second end of said side rails, said end rail intermediate said side rails and perpendicular thereto, said end rail for supporting said hand cart in a first position against a horizontal support structure;
four axle support members, said axle support members having a first end and a second end, said first end of said axle support members secured to said side rails, two of said four axle support members being mounted on each of said side rail, said axle support members being secured to said side rails and extending downward therefrom, said axle support members mounted on opposite sides of said midpoint on said side rails,
two axle connection members, said axle connection members being secured to said second end of said axle support members, said axle connection member being configured to receive an axle therein;
an axle, said axle having a first end and a second end, said axle connected to said axle support members, said axle being rotatably mounted thereto, said first end and said second of said axle being configured to have a portion extend through said axle connection members;
two wheels, said wheels being rotatably mounted to said first end and said second end of said axle on opposite sides of said frame, said wheels for providing movement of said hand cart; and
a drive assembly, said drive assembly interposed said side rails, said drive assembly operably connected to said axle, said drive assembly for moving said hand cart.

16. The hand cart as recited in claim 15, wherein said drive assembly further includes an electric motor, a battery and a chain.

17. The hand cart as recited in claim 16, and further including a lever, said lever pivotally mounted interposed said side rails proximate to said first end of said side rails, said lever having a first position and a second position, said lever configured for controlling the engagement of said drive assembly to said axle, said lever being operably connected to said drive assembly with a cable.

18. The hand cart as recited in claim 16, and further including a sprocket, said sprocket mounted intermediate on said axle, said sprocket configured to receive said chain thereon.

19. The hand cart as recited in claim 18, and further including a throttle, said throttle for controlling the speed of movement of said hand cart when said drive assembly is movably engaged with said axle.

20. The hand cart as recited in claim 19, wherein said hand cart is manufactured from aluminum.
